(19) United States
(12) Patent Application Publication
(10) Pub. No.: US 2011/0061477 A1
(43) Pub. Date: Mar. 17, 2011

(54) ACCELERATED WEATHERING TECHNIQUE

(75) Inventor: Todd Fitz, Dublin, OH (US)

(73) Assignee: HONDA MOTOR CO., INC.

(21) Appl. No.: 12/558,303

(22) Filed: Sep. 11, 2009

(51) Int. Cl. G01N 17/00

(52) U.S. Cl. 73/865.6

(57) ABSTRACT

A method for creating condensation in an accelerated weathering device, the method having the step of creating condensation in a weathering chamber of an accelerated weathering device by cooling a surface in the chamber to a temperature that is colder than the dew point of the air inside the chamber. An accelerated weathering device having a weathering chamber and at least one radiant cooling tube that is either touching or less than about 2.5 centimeters away from at least one surface in the weathering chamber so that by passing a fluid through the at least one radiant cooling tube, the temperature of the a least one surface can be decreased as a result of the radiant cooling from the radiant cooling tube.

### I. BACKGROUND OF THE INVENTION

A. Field of Invention

Embodiments are directed to devices and methods related to accelerated weathering techniques.

B. Description of the Related Art

Accelerated weathering techniques can be understood as tools that provide long-term degradation-behavior data in a shortened timeframe. Automotive manufacturers and related material suppliers typically use accelerated weathering techniques to predict how an automotive material will perform in its actual service environment. Accelerated weathering techniques help to predict a specimen's degradation behavior, and the techniques also help to avoid the delays associated with testing the specimen using only natural outdoor exposure. Accelerated weathering techniques are often applied by accelerated weathering devices. Standard types of accelerated weathering devices are well-known and commercially available. The type of equipment, including light source, temperature capability, humidity capability, and condensation mode may vary greatly between devices.

Condensation that forms on automotive paint materials leads to hydrolysis of the paint material and subsequently photooxidation and degradation of the automotive paint material. The most severe orientation for condensation is in the near horizontal positions of 0° to 15°. In this orientation, it is very difficult for water droplets to drain off of the painted surface. Additionally, this orientation allows for gravity driven water uptake into the paint film.

Some accelerated weathering test devices try to incorporate water uptake into the device design. Some devices add spray nozzles which either spray the front or back of specimen panels in a vertical orientation. Other devices incorporate water uptake by using forced air convection in a near vertical orientation.

There remains a need in the art for an accelerated weathering technique that incorporates water uptake of dew in horizontal and/or near horizontal orientations.

### II. BRIEF SUMMARY OF THE INVENTION

The present invention generally relates to an accelerated weathering device, comprising: a weathering chamber adapted to receive a work piece; a means for supporting the work piece so that a surface of the work piece is in an orientation from about 0 degrees to about 20 degrees from horizontal, wherein the means for supporting is mechanically attached to the weathering chamber, and wherein the means for supporting is adapted to be in thermal communication with a work piece; a central controller unit disposed outside the weathering chamber; a work piece temperature control device in electronic communication with the central controller unit, wherein the work piece temperature control unit comprises a temperature sensing device in electronic data communication with the central controller unit and thermal communication with the means for supporting, and wherein the work piece temperature control unit comprises a heat exchanger device in electronic controlling communication with the central controller unit and in thermal communication with the means for supporting; a humidity control unit in electronic communication with the central control unit, wherein the humidity control unit comprises a humidifier in electronic controlling communication with the central controller and in vapor communication with the weathering chamber, and wherein the humidity control unit comprises a humidity sensor in electronic data communication with the central controller and in vapor communication with the weathering chamber; and a spectral irradiation unit adapted to be placed in optical communication with a work piece, and the spectral irradiation unit being in electronic controlling communication with the central controller unit.

### IV. BRIEF DESCRIPTION OF THE DRAWINGS

The invention may take physical form in certain parts and arrangement of parts, an embodiment of which will be described in detail in this specification and illustrated in the accompanying drawings which form a part hereof and wherein:

FIG. 1 is a schematic drawing of portion of an embodiment comprising a stage for holding a work piece; and

FIG. 2 is a schematic drawing showing the elements of FIG. 1 in the context of other elements.

### V. DETAILED DESCRIPTION OF THE INVENTION

Some embodiments relate to devices and/or methods for accelerated weathering. According to some embodiments, a device for accelerated weathering can include a weathering chamber enclosing a means for supporting a work piece, a means for controlling the humidity of the atmosphere contained within the weathering chamber, a means for controlling the temperature of the work piece, and a means for irradiating the work piece with a predetermined spectrum at a predetermined power. Some embodiments optionally include a pressure regulating means for controlling the pressure of the weathering chamber. Furthermore, some embodiments may optionally include a means for controlling the partial pressure of one or more gases within the weathering chamber.

The weathering chamber can comprise a wide variety of materials and components, as will be appreciated by one of skill in the art. In some embodiments, the weathering chamber can comprise one or more of aluminum, aluminum alloy, steel, stainless steel, fiberglass composite or the like. Furthermore, the material from which the weathering chamber is fabricated can optionally be coated with a protective anti-corrosion material such as a paint. In some embodiments the weathering chamber can include an access hatch for loading and unloading work pieces. An access hatch can also include one or more seals for isolating the atmosphere contained within the weather chamber from the ambient atmosphere. One of ordinary skill in the art can select an appropriate sealing system depending on desired operating parameters such as temperature, pressure, radiant exposure, and atmospheric composition.

In some embodiments, the temperature within the weathering chamber may differ significantly from that of the ambient. Accordingly, in such embodiments an insulation system may be desirable. A wide variety of insulating systems can be appropriate depending on the specific operating characteristics of the embodiment, and one of skill in the art will readily select an appropriate system without undue experimentation. Some appropriate systems include one or more of fiberglass insulation, asbestos, Dewar devices, vacuum chambers, any of a wide variety of ceramics and the like.

A means for supporting a work piece can comprise a wide variety of devices provided the support means is adapted to orient a surface of the work piece in a position from 0 degrees to 20 degrees from horizontal. Some appropriate supporting means include a stage or platform. In some embodiments the supporting means may be fixed in a single orientation from 0 to 20 degrees, and in others the orientation can be adjustable within this range. In still other embodiments the supporting means can comprise three or more suspension cables. For instance, in one embodiment a rectangular work piece may be attached at each corner to suspension cable so that the work piece lies in a horizontal or near horizontal orientation.

Some embodiments can be adapted to use liquids other than water; however, the embodiments herein are set forth in terms of humidity. One of skill in the art will recognize that other liquids can be substituted for water and will be able to adjust the physical operating parameters of the embodiment to accommodate such alternative liquids. Humidity of the atmosphere within the weathering chamber can be controlled using a humidifier to produce water vapor. Some humidifiers can comprise a reservoir of water heated using, for instance, one or more heating elements immersed in the water and causing evaporation. Other humidifiers can comprise a reservoir of water in liquid communication with an impeller. Still other humidifiers can include an ultrasonic vaporizer or a nebulizer. In still other embodiments one or more nozzles may be added to introduce one or more aerosolized liquids to the atmosphere in the weathering chamber. A wide variety of humidifying devices are known, and one of skill in the art will be able to readily select one without undue experimentation.

In some embodiments, humidity can be further controlled using a moisture sensing device. For instance, in one embodiment a hygrometer is used to measure relative humidity. In such embodiments, the hygrometer generates an electrical signal representing a relative humidity, which can be communicated to a controller device. The controller device is also in electronic communication with the humidifier, and is adapted to use the signal from the hygrometer to turn the humidifier on, off, and/or control the rate of water vapor generation. For instance, if an 80% relative humidity is desired, an operator can program a humidity set point of 80% into the controller device. The controller then compares the data received from the hygrometer to the set point in order to determine whether the humidifier should be on or off.

In some embodiments the atmosphere may be heated, for instance, using one or more heating elements disposed in the vapor phase. In embodiments having heating elements in both the vapor and liquid phases the heating elements can be separately controlled, or even used in the alternative. Furthermore, any heating element comprising an embodiment of the present invention can be programmable, and/or manually adjustable. Furthermore, in some embodiments, the atmosphere may additionally be circulated, for instance, using one or more fans. Circulating the atmosphere can accelerate thermal and moisture equilibration, and can prevent the formation of temperature and/or moisture gradients.

A means for controlling the temperature of the work piece can take a variety of forms. For instance, in one embodiment, the work piece can be placed in thermal communication with cooling coils carrying a circulating coolant. For instance, some coolants can include chilled water, or low-boiling halogenated alkane refrigerants such as standard R-22, R-32, R-125 or R-410A HVAC refrigerants. Some embodiments can include thermoelectric Peltier cooling devices, for cooling the work piece.

In embodiments that include a stage or platform for supporting the work piece, the stage or platform can include cooling coils and/or a Peltier cooling device. Accordingly, the work piece is placed in thermal communication with the coils by placing it in thermal contact with the stage or platform. Furthermore, in such embodiments, the stage or platform may advantageously comprise a thermally conductive material such as a metal, carbon fiber composite or other appropriately conductive material.

According to some embodiments, the means for cooling the work piece can be in electronic communication with a controller. The controller can be adapted to turn the cooling means on, off, and/or control the rate of cooling. Furthermore, the controller can be in electronic communication with a temperature sensing device such as a thermocouple, thermistor, or infrared sensor, which is disposed in thermal and/or radiative communication with the work piece. According to such embodiments, a predetermined temperature can be maintained by sensing the temperature of the work piece and/or stage or platform, comparing the sensed temperature to a set point, and switching the temperature control means on or off accordingly. Additionally, it may be advantageous to include a heating element in thermal communication with the stage or platform, to assist in quickly attaining and maintaining a set temperature.

In some embodiments, it may be desirable to have the work piece at or near a dew point temperature. Accordingly, such embodiments include a means for sensing the temperature of the atmosphere in the weathering chamber, and communicating the sensed temperature to a controller unit. In some embodiments, the temperature of the weathering chamber atmosphere can be determined from the dry bulb temperature, which is already sensed by the hygrometer for calculating relative humidity. In other embodiments, a separate temperature sensing element may be appropriate. The controller unit is adapted to calculate the dew point, using known algorithms, from sensed relative humidity and air temperature data. The means for controlling the temperature of the work piece can use the calculated dew point as a set point about which it maintains the work piece temperature.

A means for irradiating a work piece can take a wide variety of forms depending on the specific application. One of skill in the art will readily select an appropriate means based on the spectrum, and power desired. Some appropriate sources include, without limitation, mercury vapor lamps, tungsten filament lamps, carbon arc lamps, halogen lamps, metal halide lamps, and xenon arc lamps. Furthermore, in the case of arc lamps, suitable lamps can be continuous short arc, continuous long arc, or flash lamps. In some embodiments, a continuous arc lamp can be used in a pulsed mode, for instance, by pulsing the lamp's power source. Suitable lamps can operate at wattages of about 100 Watts to about 100,000 Watts.

Other suitable ranges include about 100 Watts to 500 Watts, 500 Watts to 1500 Watts, 1500 Watts to 2000 Watts, 2000 Watts to 2500 Watts, 2500 Watts to 3000 Watts, 3000 Watts to 3500 Watts, 3500 Watts to 4000 Watts, 4000 Watts to 4500 Watts, 4500 Watts to 5000 Watts, 5000 Watts to 5500 Watts, 5500 Watts to 6000 Watts, 6000 Watts to 6500 Watts, 6500 Watts to 7000 Watts, 7000 Watts to 7500 Watts, 7500 Watts to 8000 Watts, 8000 Watts to 8500 Watts, 8500 Watts to 9000 Watts, 9000 Watts to 9500 Watts, 9500 Watts to 10,000 Watts, 10,000 Watts to 15,000 Watts, 15,000 Watts to 20,000 Watts, 20,000 Watts to 25,000 Watts, 25,000 Watts to 30,000 Watts, 30,000 Watts to 35,000 Watts, 35,000 Watts to 40,000 Watts, 40,000 Watts to 45,000 Watts, 45,000 Watts to 50,000 Watts, 50,000 Watts to 55,000 Watts, 55,000 Watts to 60,000 Watts, 60,000 Watts to 65,000 Watts, 65,000 Watts to 70,000 Watts, 70,000 Watts to 75,000 Watts, 75,000 Watts to 80,000 Watts, 80,000 Watts to 85,000 Watts, 85,000 Watts to 90,000 Watts, 90,000 Watts to 95,000 Watts, or even 95,000 Watts to 100,000 Watts. Here as elsewhere in the specification and claims, ranges may be combined.

Some embodiments can also include one or more systems for controlling gas pressure within the weathering chamber. For instance, some embodiments include the capacity to maintain a selected pressure regardless of ambient atmospheric pressure. Furthermore, selected pressures can be above, below and/or equal to atmospheric pressure. In some embodiments, a gas manifold is included for maintaining an elevated pressure. Furthermore, the composition of the atmosphere can be controlled according to known methods, by adjusting the partial pressure of component gases, such as oxygen, nitrogen, and other air gases or additive gasses and the like. Some embodiments can optionally include a vacuum manifold for evacuating the weathering chamber atmosphere. Embodiments having both gas and vacuum manifolds can have a wide operating pressure. For instance, some suitable pressures can be from a low vacuum of about 25 Torr to several atmospheres of about 3800 Torr.

Other suitable ranges can be from about 25 Torr to about 100 Torr, about 100 Torr to about 200 Torr, about 200 Torr to about 300 Torr, about 300 Torr to about 400 Torr, about 400 Torr to about 500 Torr, about 500 Torr to about 600 Torr, about 600 Torr to about 700 Torr, about 700 Torr to about 800 Torr, about 800 Torr to about 900 Torr, about 900 Torr to about 1000 Torr, about 1000 Torr to about 1100 Torr, about 1100 Torr to about 1200 Torr, about 1200 Torr to about 1300 Torr, about 1300 Torr to about 1400 Torr, about 1400 Torr to about 1500 Torr, about 1500 Torr to about 1600 Torr, about 1600 Torr to about 1700 Torr, about 1700 Torr to about 1800 Torr, about 1800 Torr to about 1900 Torr, about 1900 Torr to about 2000 Torr, about 2100 Torr to about 2200 Torr, about 2200 Torr to about 2300 Torr, about 2300 Torr to about 2400 Torr, about 2400 Torr to about 2500 Torr, about 2500 Torr to about 2600 Torr, about 2600 Torr to about 2700 Torr, about 2700 Torr to about 2800 Torr, about 2800 Torr to about 2900 Torr, about 2900 Torr to about 3000 Torr, about 3000 Torr to about 3100 Torr, about 3100 Torr to about 3200 Torr, about 3200 Torr to about 3300 Torr, about 3300 Torr to about 3400 Torr, about 3400 Torr to about 3500 Torr, about 3500 Torr to about 3600 Torr, about 3600 Torr to about 3700 Torr, or even about 3700 Torr to about 3800 Torr.

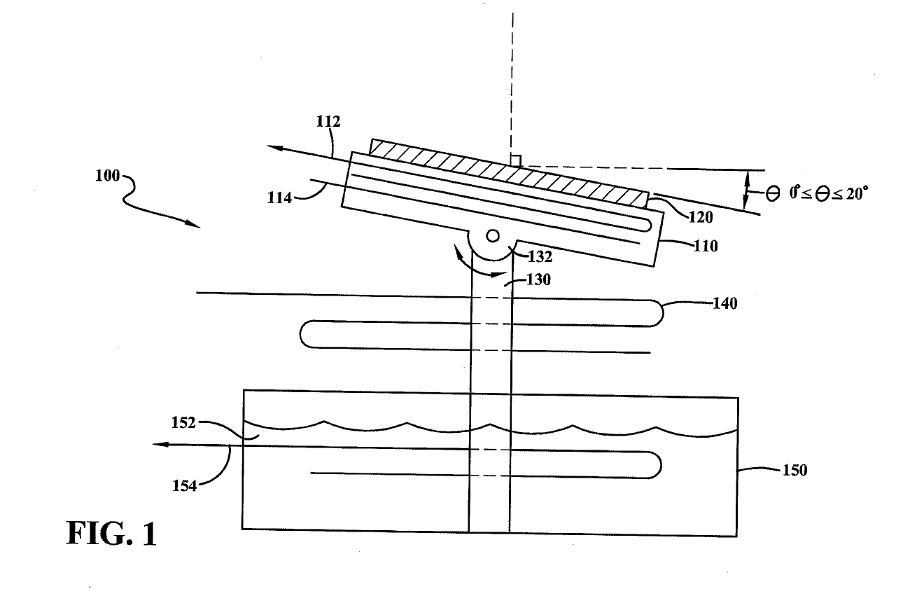

Turning now to the Figures, FIG. 1 is a schematic drawing of a portion of an embodiment 100. The portion 100 comprises a stand for supporting a work piece 120. The stand further comprises a platform member 110 pivotably connected to a base portion 130 at a pivot joint 132. The platform 110 in this example has a range of motion from about 0 degrees to about 20 degrees from horizontal. Furthermore, the platform 110 includes an integrated heating/cooling means 112 comprising metal tubing 112. The tubing 112 is adapted to receive circulating chilled coolant or heated liquids. In this example, the temperature of the platform 110 is sensed using an embedded thermocouple 114. This example also includes an optional air heating element 140. The base 130 is mounted in a reservoir 150 of water 152. The reservoir 150 includes an electric resistance heating element 154 to case evaporation of water 152 into the surrounding atmosphere.

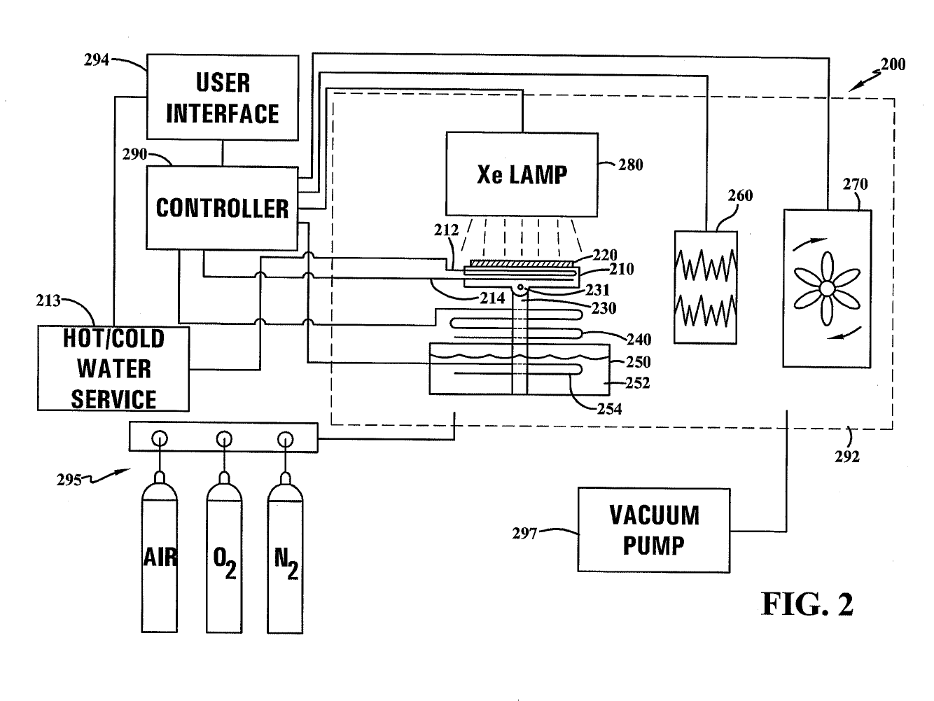

FIG. 2 is a schematic drawing of an embodiment 200 showing the elements of FIG. 1 in the context of additional elements. Here, the work piece 220 is disposed on and in thermal communication with platform 210. Platform 210 includes an integrated heat exchanger 212 adapted to receive circulating heated or chilled liquids from a source 213, which is in electronic controlling communication with controller 290. Temperature of the platform 210 is sensed by embedded thermocouple 214, which communicates temperature data to controller 290. Accordingly, the controller 290 can control the temperature of the platform 210 to attain and/or maintain a set point temperature. Such set point may be hard coded into the controller, or may be programmed into the embodiment 200 through a user interface 294.

According to this example, the temperature of the work piece is assumed to be the same as the platform 210. However, one of skill in the art will recognize that a variety of alternatives are available. For instance, the temperature of the work piece could be sensed directly, or temperature data collected from the platform 210 could be corrected according to a calibration curve.

With further regard to FIG. 2, this embodiment 200 includes a reservoir 250 of water 252 and a resistance heater 254 for causing the water 252 to evaporate. The resistance heater 254 is in electronic controlling communication with controller 290. Furthermore, the embodiment includes a hygrometer 260 in electronic data communication with the controller 290 and is adapted to transmit humidity data to the controller 290. Thus, the power to the resistance heater 254 can be adjusted in response to humidity data received from the hygrometer 260 to attain and/or maintain a predetermined set point. Such set point may be hard coded into the controller, or may be programmed into the embodiment 200 through a user interface 294.

Also in reference to FIG. 2, this embodiment 200 includes an optional air heating element 240 comprising a resistance heater 240. According to this embodiment 200, the dry bulb temperature of the hygrometer 260 is communicated to the controller 290 and used to determine the air temperature in the weathering chamber 292. Thus, the controller 290 can adjust the power to the resistance heater 240 to attain and/or maintain a predetermined set point. Such set point may be hard coded into the controller, or may be programmed into the embodiment 200 through a user interface 294.

The embodiment 200 shown in FIG. 2 also includes an optional fan 270 for circulating gases in the weathering chamber 292. While not required, such a fan 270 may be desirable for quickly attaining thermal equilibrium, and preventing the formation of thermal and concentration gradients. According to this embodiment the fan 270 is in electronic controlling communication with the controller 290, and may be, for instance, controlled according to a set program, controlled in response to sensor data received by the controller 290, it may be on continuously, and/or it may be turn on and off manually through the user interface 294.

The embodiment of FIG. 2 also includes a xenon arc lamp 280 for irradiating the work piece 220 with a predetermined spectrum and power of electromagnetic energy. According to this embodiment, the xenon lamp 280 is in electronic controlling communication with the controller 290 and can be operated according to any appropriate power profile including constant power, pulsed power, or any appropriate non-pulsed variable program. Further according to this embodiment 200, the xenon lamp 280 does not include optics between the lamp 280 and the work piece 220. However, any appropriate optics can be included and appropriate optical arrangements can be determined by one of skill in the art without undue experimentation. For instance, larger exposure areas may be desirable. Thus, the skilled artisan may elect to include a diffusing lens. Still further, some embodiments may include optical filters such as, without limitation band pass filters, and/or neutral density filters. Alternatively, focused power may be more important for a given application. Thus, a collimator may be incorporated. Other optics can be included to adjust beam size, power, phase angle, band width and any of a wide variety of other optical parameters that the skilled artisan may deem important to a give test.

This embodiment 200 also includes an optional gas manifold 295 connected to a plurality of air gas bottles. Accordingly, selected pressures of air, oxygen and nitrogen can be added to the weathering chamber 292. Thus, some tests can use ordinary air, oxygen enriched air, or nitrogen enriched air. Other gases can be attached to the manifold 295 as needed. Additionally, an optional vacuum pump 297 is included in this embodiment for evacuating the weathering chamber 292. Thus, if a non-air mixture is desired, the atmosphere can be readily exchanged. Furthermore, if a reduced-pressure atmosphere test is desired, the embodiment 200 can be operated at less than atmospheric pressure. One of skill in the art will recognize that a variety of pumps can be appropriate depending on the degree of vacuum desired. Furthermore, one of skill in the art will recognize that a variety of plumbing schemes and devices can be added to the embodiment 200 as drawn to further improve performance.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. An accelerated weathering device, comprising:
a weathering chamber adapted to receive a work piece;
a means for supporting the work piece so that a surface of the work piece is in an orientation from about 0 degrees to about 20 degrees from horizontal, wherein the means for supporting is mechanically attached to the weathering chamber, and wherein the means for supporting is adapted to be in thermal communication with a work piece;
a central controller unit disposed outside the weathering chamber;
a work piece temperature control device in electronic communication with the central controller unit, wherein the work piece temperature control unit comprises a temperature sensing device in electronic data communication with the central controller unit and thermal communication with the means for supporting, and wherein the work piece temperature control unit comprises a heat exchanger device in electronic controlling communication with the central controller unit and in thermal communication with the means for supporting;
a humidity control unit in electronic communication with the central control unit, wherein the humidity control unit comprises a humidifier in electronic controlling communication with the central controller and in vapor communication with the weathering chamber, and wherein the humidity control unit comprises a humidity sensor in electronic data communication with the central controller and in vapor communication with the weathering chamber; and
a spectral irradiation unit adapted to be placed in optical communication with a work piece, and the spectral irradiation unit being in electronic controlling communication with the central controller unit.

2. The device of claim 1, wherein the weathering chamber further comprises a thermal insulating system selected from one or more of fiberglass insulation, ceramic insulation, asbestos, or a vacuum chamber.

3. The device of claim 1, wherein the weathering chamber is adapted to maintain a gas pressure from about 25 Torr to about 3800 Torr within the weathering chamber.

4. The device of claim 1, wherein the central control unit includes work piece temperature settings, relative humidity settings, and/or time variable work piece temperature and relative humidity settings.

5. The device of claim 1, wherein the heat exchanger device comprises circulating water cooling coils, refrigeration coils, or Peltier cooling device.

6. The device of claim 1, wherein the temperature sensing device is selected from one or more of a thermocouple, a thermistor, an infrared temperature sensor.

7. The device of claim 1, wherein the humidifier of the humidity control unit further comprises an evaporative humidifier, an impeller humidifier, or an ultrasonic humidifier.

8. The device of claim 1, wherein the humidity sensor comprises an electronically controllable hygrometer adapted to generate an electronic signal and transmit the signal to the central controller unit.

9. The device of claim 8, wherein the hygrometer comprises a wet bulb and dry bulb, and is adapted to transmit dry bulb temperature data to the central controller unit.

10. The device of claim 1, wherein the spectral irradiation unit comprises one or more of a xenon short arc lamp, a xenon long arc lamp, a xenon flash lamp, a mercury vapor lamp, a tungsten filament lamp, a halogen lamp, or a metal halide lamp.

11. The device of claim 10, wherein the radiation exposure area is less than 2500 in².

12. The device of claim 10, wherein the spectral irradiation unit has an output power from about 100 to about 100,000 Watts.

13. The device of claim 12, wherein the spectral irradiation unit has an output power from about 1000 to about 50,000 Watts.

14. The device of claim 1, further comprising an air temperature control unit in electronic communication with the central control unit.

15. The device of claim 14, wherein the air temperature control unit comprises a temperature sensor in thermal communication with the atmosphere within the weathering chamber and in electronic data communication with the central controller unit, and wherein the air temperature control unit comprises a heater in thermal communication with the atmosphere within the weathering chamber and in electronic controlling communication with the central controller unit.

16. The device of claim 1 further comprising a gas manifold in fluid communication with the weathering chamber and adapted to add predetermined gas pressures to the weathering chamber.

17. The device of claim 16, wherein controlling the gas manifold is adapted to regulate the partial pressure of one or more gases in the weathering chamber, wherein the gas is selected from one or more of oxygen, nitrogen, ozone, carbon dioxide, or carbon monoxide.

18. The device of claim 1, further comprising a vacuum pump in fluid communication with the weathering chamber and adapted to reduce the gas pressure in the weathering chamber.

19. The device of claim 1, further comprising a user interface including a key pad for inputting experimental parameters, and a readout adapted to display the status of one or more component units.

20. The device of claim 1, further comprising at least one optical filter disposed in the optical path between the spectral irradiation unit and the work piece.
